(19) United States
(12) Patent Application Publication
(10) Pub. No.: US 2021/0125145 A1
(43) Pub. Date: Apr. 29, 2021

(54) Methods and a System for Opportunistic Delivery

(71) Applicants: David Thomas Petrie, Dundeee (GB); Laura Docherty, Dundee (GB); Craig Garrigan, Dundee (GB)

(72) Inventors: David Thomas Petrie, Dundeee (GB); Laura Docherty, Dundee (GB); Craig Garrigan, Dundee (GB)

(21) Appl. No.: 16/666,674

(22) Filed: Oct. 29, 2019

(51) Int. Cl. G06Q 10/08; G06Q 30/02; G06N 20/00

(52) U.S. Cl. CPC G06Q 10/08355; G06N 20/00; G06Q 10/0838; G06Q 30/0235

(57) ABSTRACT

A delivery is scheduled for orders. A delivery route for the delivery is planned. A determination is made that a delivery vehicle associated with the delivery is below a threshold capacity level with the orders. Potential customers along the delivery route are identified and contacted for placing new orders. Any received new orders are added to the orders as a modified delivery for the delivery truck along the delivery route.

### BACKGROUND

Increasingly consumers are having products (goods and food orders) delivered directly to their homes; rather than purchasing the products while at brick-and-mortar stores. Third-party delivery services and suppliers have spurred the increased demand by making it possible for brick-and-mortar stores to sell products without having to maintain delivery equipment, delivery software, and delivery personnel.

Brick-and-mortar stores that continue to maintain their own delivery systems continue to struggle with inefficiencies associated with timely and cost-effective delivery of their goods to their customers. However, even the third-party delivery services and suppliers face a number of cost inefficiencies, such as when deliveries are being made to a single consumer for a single order of products. These inefficiencies are associated with planning deliveries, maximizing the number of orders that can be fulfilled during any given delivery, and timely delivering the products to consumers.

It is not just third-party delivery services, suppliers, and stores that can benefit from more efficient deliveries because consumers can benefit as well.

For example, consider a consumer arriving home and realizing that he/she forgot to pick up some needed items from a local supermarket. The consumer must travel back to the supermarket for the items; however, concurrent with this situation, the local supermarket has a delivery truck that is about to disembark from the supermarket to deliver items for orders that were recently received along a planned delivery route with a delivery truck that is not at full capacity. The consumer happens to be on the planned delivery route. Neither the consumer nor the supermarket are aware of their joint and compatible needs, and as such there is a lost opportunity for both the consumer and the supermarket.

As another example, consider a third-party haulage company that has spare space on a delivery truck associated with a planned delivery, which they desire to fill as this would be much more cost effective than sending out a partial loaded truck. Concurrently, a retailer in vicinity of the haulage company recently received a sizable order from one of its customers, which could be delivered much sooner to the customer if the space availability of the haulage delivery truck was known to the retailers. Neither the haulage company nor the retailer are aware of their joint and compatible needs.

### SUMMARY

In various embodiments, methods and a system for opportunistic delivery are presented.

According to an aspect, a method for opportunistic delivery is presented. A delivery that is scheduled with a first amount of orders is identified. A planned capacity level for the first amount of orders on a vehicle, which is associated with the delivery, is determined to be below a threshold capacity level associated with the vehicle. A list of customers that are located on or adjacent to a route for the delivery is generated. Requests for new orders are sent to one or more of the customers on the list. The delivery is modified with any new orders processed as a result of sending the requests and the planned capacity level on the vehicle is increased based on the new orders.

### BRIEF DESCRIPTION OF THE DRAWINGS

FIG. 1 is a diagram of a system for opportunistic delivery, according to an example embodiment.

FIG. 2 is a diagram of a method for opportunistic delivery, according to an example embodiment.

FIG. 3 is a diagram of another method for opportunistic delivery, according to an example embodiment.

FIG. 4 is a diagram of another system for opportunistic delivery, according to an example embodiment.

### DETAILED DESCRIPTION

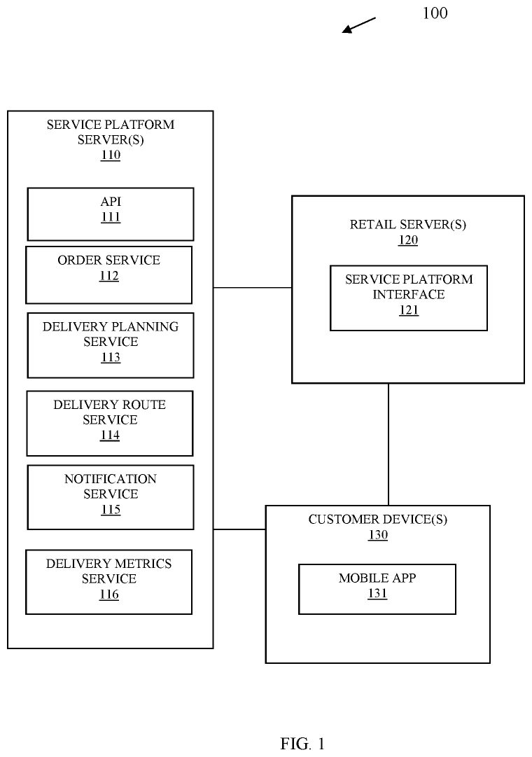

FIG. 1 is a diagram of a system 100 for opportunistic delivery, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of opportunistic delivery presented herein and below.

The system includes service platform servers 110, retail servers 120, and customer devices 130. Each device 110, 120, and 130 includes its own processors and non-transitory computer-readable storage media comprising executable instructions representing: 1) for server 110: an Application Programming Interface (API) 111, an order service 112, a delivery planning service 113, a delivery route service 114, a notification service 115, and a delivery metrics service 116; 2) for retail server 120: a service platform interface 121; and 3) for customer device 130: a mobile application (app) 131.

The executable instructions when executed by the processors of the corresponding devices 110, 120, and 130 perform the processing discussed herein and below with respect to: API 111, order service 112, delivery planning service 113, delivery route service 114, notification service 115, delivery metrics service 115, service platform interface 121, and mobile app 131.

It is noted that although single service platform server 110, retail server 120, and customer device 130 are illustrated it is to be noted that a plurality of such devices may be present. Moreover, service platform server 110 may comprise a plurality of servers 110 that logically cooperate as a cloud processing environment of a cloud. Still further, any of the components 112-116 may reside within different cloud environments from others of the components 112-116. As such, components 112-116 may be viewed as microservices available through API 111.

As will be demonstrated more completely herein and below, system 100 permits a variety of opportunistic delivery services.

Retailers access the API 111 using service platform interface 121 to perform operations with microservices 112-116. The microservices 112-116 allow retailers to satisfy customer orders through order service 112, plan order fulfillment and delivery through delivery planning service 113 and generate any given delivery's route through delivery route service 114.

Once a delivery is planned to satisfy orders and a delivery route generated, service platform interface 121 allows an option for retailers to indicate whether a delivery truck or vehicle is completely full or a percentage full with products for the delivery (25% full, 50% full, 75% full, or 100% full—other increments indicating a percentage of capacity may be used such as in 10% increments). Once delivery planning service 113 receives a percentage of capacity for which the delivery vehicle is at for the delivery from service platform interface 121 and the delivery route is provided from the delivery route service 114, planning service 113 identifies known customers that are known to be along the delivery route that are not scheduled to receive any product for the delivery. Identification of customers along the route can be achieved using known addresses for customers of the retailer and the street names along the delivery route. In an embodiment, the customer addresses do not have to be on the streets for the generated route; rather, intersecting or adjacent streets with known customer addresses may be used and compared to the route, and when such addresses are within a predefined threshold distance (for example, a half of a mile), such customer addresses may be considered as potential customers to contact.

Planning service 113 generates a listing of potential customers that have matched addresses along the route or that have addresses within a threshold distance of deviation from the route. Contact information for these potential customers of the list are obtained from customer records associated with the customers of the retailer. The contact information for any given customer may include, an email, a mobile phone number, a landline phone number, a social media identifier, and/or a known registered unique identifier for mobile app 131.

Planning service 113 then notifies service platform interface 121 of the list of potential customers and/or the corresponding customer contact information that may be contacted with offers, requests, or enticements for purposes of attempting to generate orders through order service 112 to increase the capacity of the delivery vehicle for the planned delivery. Service platform interface 121 then identifies all the potential customers of a select list of the potential customers and any offer or request that is to be made to the selected potential customers. The selected potential customers and the offer or request is provided from service platform interface 121 to notification service 113 (again it is noted that interaction between service platform interface 121 and microservices 112-116 is performed through API 111). Notification service 115 then uses contact information for the selected potential customers to deliver the specific offer or request to mobile apps 131 of those customers. Any customer accepting the offer or request, is routed through app 131 to order service 112 for placing an order. Once order service 112 confirms the order, delivery planning service 113 updates the items that are to be delivered along the delivery route for the original delivery to include the new customer orders that were confirmed. In some cases, if any of the new customers associated with the delivery are on streets that deviate from the original planned route (as was discussed above), delivery route service 114 updates the delivery route to include the deviations to the streets for the new ordering customers.

The retailer associated with service platform interface 121 may then determine whether the delivery vehicle is at full capacity based on the new received orders or determine if the delivery vehicle is at an acceptable level of capacity. Assuming that it is, the delivery vehicle disembarks along the delivery route or the updated delivery route with the items associated with customers scheduled for delivery when the delivery route was first and initially generated and with new items associated with customers that were added to the delivery route or the updated delivery route.

If the delivery vehicle is still at an unacceptable level of capacity for the scheduled delivery, the retailer, using service platform interface 121 may iterate with new and different offers or enticements to customers along the route that have still not placed an order using API 111 and microservices 112-116 as discussed above.

In an embodiment, service platform interface 121 through API 111 may supply predefined rules that are dynamically evaluated by planning service 113 to determine permissible deviations to the original generated delivery route, selection of potential customers from customers along the route (or deviating slightly within a threshold from the route) and offers or enticements to make to the potential customers for the planned delivery.

In an embodiment, service platform interface 121 through API 111 may supply predefined rules that are dynamically evaluated by planning service 113 for determining a capacity level of a given delivery vehicle from a delivery having items. In an embodiment, a machine-learning algorithm is trained on deliveries with items associated with those deliveries and a given delivery vehicle or delivery vehicle type. Planning service 113 uses the trained machine learning algorithm to make autonomous decisions as to the capacity of a given delivery vehicle for a given delivery having specific items of the retailer. The level of capacity is then matched to retailer-defined rules to determine whether potential ordering customers are to be identified and contacted for placing orders using specific offers defined by the retailer. The retailer provides the delivery vehicle identifier or type for deliveries and predefined the rules and offers through the service platform interface 121. In this way, system 100 may be fully autonomous once the rules and offers are defined and the machine-learning algorithm is trained on vehicles or vehicle types of the retailer for deliveries (each delivery having specific items/products).

The system 100 provides opportunistic deliveries by obtaining new customer orders for a given delivery planned by a retailer for purposes of optimizing the capacity of the delivery vehicle for the planned delivery. It allows customers to receive offers or enticements from the retailer while allowing the retailer to achieve optimal delivery vehicle capacity for any given planned delivery.

It is to be noted, that a “customer” as used herein does not have to be a consumer; rather, a customer can also be another retailer. Moreover, a “retailer” can be a supplier as used herein. So, a first retailer associated with retail server 120 may be a supplier while customers and potential customers of the planned deliveries are other retailers/businesses that are supplied by the first retailer. The retailer of retail server 120 may also be a third-party online delivery service that buys products (food or non-food) from a different retailer (restaurant or grocery store) and delivers the products to consumers subscribing to the third-party online delivery service. Here, the delivery vehicle may be a car; rather than a truck. Of course, a retailer of retail server 120 may also be a consumer-facing retailer that delivers its own products to customers/consumers of that retailer. In this way, system 100 can provide opportunistic deliveries to host of different situations (retailer-to-retailer, retailer-to-consumer, supplier-to-retailer, third-party online service to consumer, etc.).

In an embodiment, system 100 includes delivery metrics service 116 which maintains a total number of orders associated with each first-placed or original planned delivery and a final total number of orders after the additional orders are received for the modified delivery. The net increase in orders may be used to generate metrics such as average fuel cost per order being originally $X for the original total number of orders and new average fuel cost per order reduced to $Y for the final total number of orders. Service platform interface 121 may use API 111 to generate reports using display metrics service 116 showing the savings per fuel cost realized for each delivery with the increased orders added to the modified delivery. The reports can be based on any retail-desired time period (1-year, 1-month, per quarter, etc.).

In an embodiment, the offer or enticement sent to the customer by the notification service 115 includes a time of day and calendar day before which the potential ordering customer has to place an order to receive the offer. For example, place an order for groceries within the next 30 minutes for no delivery charge. That is, because the delivery is attempting to be optimized with enough orders to fill a delivery vehicle to capacity, the offers will typically have a time-dependent offer so as to not delay the original planned delivery.

In an embodiment, notification service 115 may be managed or provided through retail server 120; rather than service platform server 110.

In an embodiment, customer devices 130 can include mobile phones, laptops, tablets, wearable processing devices, voice enabled and network-based Internet-Of-Things (IoTs) devices (such as Amazon Echo®, Google Home®, Apple Siri®), or desktop computers.

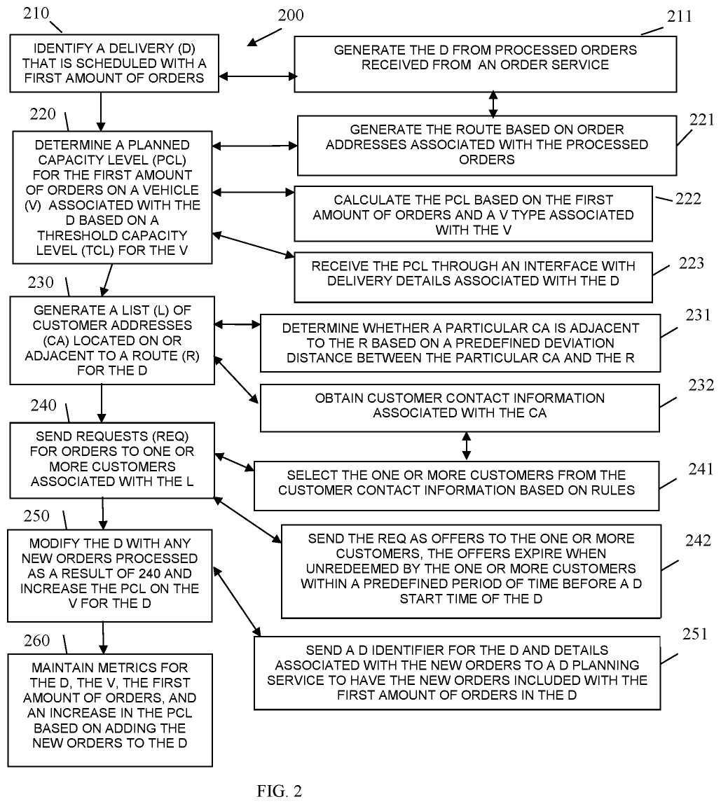

These and other embodiments are now discussed with reference to FIGS. 2-4.

FIG. 2 is a diagram of a method 200 for opportunistic delivery, according to an example embodiment. The software module(s) that implements the method 200 is referred to as an “opportunistic delivery manager.” The opportunistic delivery manager is implemented as executable instructions programmed and residing within memory and/or a non-transitory computer-readable (processor-readable) storage medium and executed by one or more processors of a device. The processor(s) of the device that executes the opportunistic delivery manager are specifically configured and programmed to process the opportunistic delivery manager. The opportunistic delivery manager may include one or more wireless network connections during operation.

In an embodiment, the device that executes the opportunistic delivery manager is server 110. In an embodiment, server 110 is a server that is part of a collection of servers that cooperate as a cloud processing environment or cloud.

In an embodiment, the opportunistic delivery manager is all of or some combination of: API 111, order service 112, delivery planning service 113, delivery route service 114, notification service 115, and/or delivery metrics service 116.

At 210, the opportunistic delivery manager identifies a delivery that is associated with a first amount of orders. Each order including one or more products or items and being directed to a particular customer address (consumer or retailer address) for delivery.

In an embodiment, at 211, the opportunistic delivery manager generates the delivery from processed orders received from an order service 112.

At 220, the opportunistic delivery manager determines a planned capacity level for the first amount of orders on a vehicle associated with the delivery based on a threshold capacity level for the vehicle.

In an embodiment of 211 and 220, at 221, the opportunistic delivery manager generates the route based on order addresses associated with the processed orders.

In an embodiment, at 222, the opportunistic delivery manager calculates the planned capacity level based on the first amount of orders and a vehicle type associated with the vehicle.

In an embodiment, at 223, the opportunistic delivery manager receives the planned capacity level through an interface with delivery details associated with the delivery. In an embodiment, the interface is platform interface 121.

At 230, the opportunistic delivery manager generates a list of customer addresses that are located on or adjacent to a route for the delivery.

In an embodiment, at 231, the opportunistic delivery manager determines whether a particular customer address is adjacent to the route based on a predefined deviation distance between the particular customer address and the route (e.g., less than a half mile from a planned street on the route, etc.).

In an embodiment, at 232, the opportunistic delivery manager obtains customer contact information associated with the customer addresses.

At 240, the opportunistic delivery manager sends requests for orders to one or more customers associated with the list.

In an embodiment of 232 and 240, at 241, the opportunistic delivery manager selects the one or more customers from the customer contact information based on rules. In an embodiment, the rules are defined through interface 121.

In an embodiment, at 242, the opportunistic delivery manager sends the requests as offers to the one or more customers. The offers expire when unredeemed by the one or more customers within a predefined period or time before a delivery start time of the delivery.

At 250, the opportunistic delivery manager modifies the delivery with any new orders processed as a result of 240 and increases the planned capacity level on the vehicle for the delivery with order details of the new orders.

In an embodiment, at 251, the opportunistic delivery manager sends a delivery identifier for the delivery and details associated with the new orders to a delivery planning service 113 to have the new orders included with the first amount of orders on the vehicle for the delivery.

In an embodiment, at 260, the opportunistic delivery manager maintains metrics for the delivery, the vehicle, the first amount of orders, and an increase in the planned capacity level based on adding the new orders to the delivery before the vehicle departs for the delivery at a delivery start time.

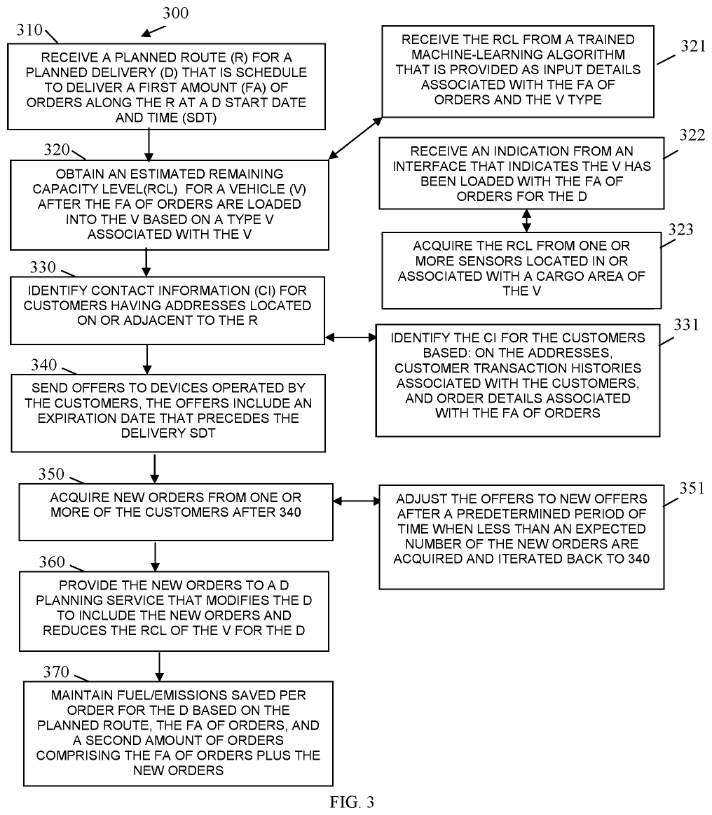

FIG. 3 is a diagram of another method 300 for opportunistic delivery, according to an example embodiment. The software module(s) that implements the method 300 is referred to as an “order-delivery manager.” The order-delivery manager is implemented as executable instructions programmed and residing within memory and/or a non-transitory computer-readable (processor-readable) storage medium and executed by a device. The processors that execute the order-delivery manager are specifically configured and programmed to process the order-delivery manager. The order-delivery manager includes one or more network connections during its processing. Any network connections to the device can be wired, wireless, or a combination of wired and wireless.

In an embodiment, the device that executes the order-delivery manager is server 110. In an embodiment, the server 110 is part of a cloud processing environment (cloud).

In an embodiment, the order-delivery manager is all or some combination of: API 111, order service 112, delivery planning service 113, delivery route service 114, notification service 115, delivery metrics service 116, and/or method 200 of FIG. 2.

The processing of the order-delivery manager as shown in FIG. 3 represents another and in some ways enhanced processing perspective of method 200 of FIG. 2.

At 310, the order-delivery manager receives a planned route for a planned delivery that is scheduled to deliver a first amount of orders along the planned route at a delivery start date and time.

At 320, the order-delivery manager obtains an estimated remaining capacity level for a vehicle after the first amount of orders are loaded into the vehicle based on a type of vehicle associated with the vehicle.

In an embodiment, at 321, the order-delivery manager receives the remaining capacity level from a trained machine-learning algorithm that is provided as input details associated with the first amount of orders and the vehicle type for the vehicle.

In an embodiment, at 322, the order-delivery manager receives an indication from an interface 121 that indicates the vehicle has been loaded with the first amount of orders for the delivery.

In an embodiment of 322 and at 323, the order-delivery manager acquires or calculates the remaining capacity level from one or more sensors located in or associated with a cargo area of the vehicle. The sensors may be image sensors, that capture images of the cargo area, the images processed to determining remaining space within the cargo area after the first amount of orders are loaded into the cargo area.

At 330, the order-delivery manager identifies contact information for customers having addresses located on or adjacent to the route or routes planned streets.

In an embodiment, at 331, the order-delivery manager identifies the contact information for the customers based on a variety of factors that can include: the addresses, customer transaction histories for customers associated with the addresses, and order details associated with the first amount of orders.

At 340, the order-delivery manager sends offers to devices 130 operated by the customers. The offers include an expiration date that precedes the delivery start date and time.

At 350, the order-delivery manager acquires new orders from one or more of the customers after or responsive to 340.

In an embodiment, at 351, the order-delivery manager adjusts the offers to new offers after a predetermined period of time when less than an expected number of the new orders are received/acquired, and the order-delivery manager iterates back to 340 to send the new offers. This iteration can exclude any customers that responded to the first offer and already placed one of the new orders, such that only non-responding customers are contacted the second time with the new offer.

At 360, the order-delivery manager provides the new orders to a delivery planning service 113 that modifies the delivery to include the new orders and reduces the estimated remaining capacity level of the vehicle for the delivery before the delivery start date and time.

In an embodiment, at 370, maintains fuel/emissions saved per order for the delivery based on the planned route, the first amount of orders, and a second amount of orders comprising the first amount of orders plus the new orders. That is, a per-order fuel/emission rate or cost is calculated for just the first amount of orders and then again for the first amount of orders plus the new orders (which will be lower on a per-order basis).

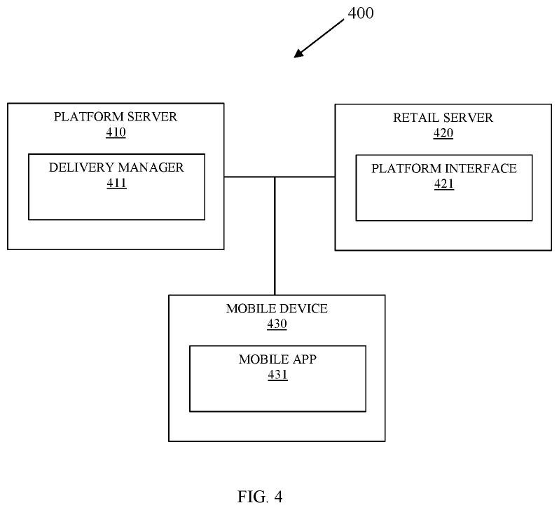

FIG. 4 illustrates a system 400 for opportunistic delivery, according to an example embodiment. The system 400 includes a variety of hardware components configured to execute software components. The system 400 has access to one or more network connections during processing of the software components. The network connections may be wired, wireless, or a combination of both wired and wireless.

In an embodiment, the system 400 is the system 100.

In an embodiment, the system 400 implements, inter alia, the processing discussed above with the FIGS. 1-3.

The system 400 includes: a server-platform server 410, a retail server 420, and a mobile device 430.

The server-platform service 410 comprising a platform processor and a platform non-transitory computer-readable storage medium having executable instructions representing a delivery manager 411.

The delivery manager 411 when executed by the platform processor from the platform non-transitory computer-readable storage medium causes the platform processor to: 1) generate a delivery from a first amount of orders based on order addresses associated with the first amount of orders; 2) generate a delivery route for the delivery; 3) receive a remaining capacity level for a delivery vehicle from the platform interface 421, the vehicle is scheduled to deliver the first amount of orders along the delivery route; 4) identify contact information for a customer of a retailer that has a customer address along or adjacent to the delivery route; 5) obtain an offer from the platform interface 421 associated with the retailer to entice the customer to place a new order for the delivery; 6) send the offer to the mobile application 431 of the mobile device 430, which is operated by the customer using the contact information; 7) receive the new order for the delivery from the mobile application 431 after sending the offer; and 8) modify the delivery to include the new order with the first amount of orders.

The retail server 420 comprising a retail processor and a retail non-transitory computer-readable storage medium having the platform interface 421.

The platform interface 421 when executed by the retail processor from the retail non-transitory computer-readable storage medium comprises the retail processor to: 1) provide the remaining capacity level to the delivery manager 411 after the vehicle is loaded with the first amount of orders for the delivery; 2) provide the offer to the delivery manager 411 based on the contact information of the customer provided by the delivery manager 411 and order details associated with the first amount of orders of the delivery; 3) send the new order details to a vehicle loading device to cause the vehicle to add the new order to the vehicle with the first amount of orders.

The mobile device 430 comprising a mobile processor and a mobile non-transitory computer-readable storage medium having executable instructions representing a mobile application (app) 431.

The app 431 when executed by the mobile processor from the mobile non-transitory computer-readable storage medium causes the mobile processor to: 1) receive the offer from the delivery manager 411; and 2) place the new order based on options selected by the customer through an order interface with the delivery manager 411.

In an embodiment, the platform server 410 is server 110. In an embodiment, server 110 is part of a cloud or cloud processing environment.

In an embodiment, the delivery manager 411 is all of or some combination of: API 111, order service 112, delivery planning service 113, delivery route service 114, notification service 114, delivery metrics service 116, the method 200 of the FIG. 2, and/or the method 300 of the FIG. 3.

In an embodiment, retail server 420 is server 120. In an embodiment, server 120 is part of a cloud processing environment (cloud).

In an embodiment, platform interface 421 is interface 121.

In an embodiment, mobile device 430 is device 130. In an embodiment, device 130 is a tablet, a laptop, a phone, a wearable processing device, a voice network-enabled IoTs device, or a desktop computer.

In an embodiment, app 431 is app 131.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying a delivery that is scheduled with a first amount of orders;
determining a planned capacity level for the first amount of orders on a vehicle associated with the delivery based on a threshold capacity level for the vehicle;
generating a list of customer addresses located on or adjacent to a route for the delivery;
sending requests for orders to one or more customers associated with the list; and
modifying the delivery with any new orders processed as a result of the sending and increasing the planned capacity level on the vehicle for the delivery.

2. The method of claim 1, wherein identifying further includes generating the delivery based on processed orders received from an order service.

3. The method of claim 2, wherein determining further includes generating the route based on order addresses associated with the processed orders.

4. The method of claim 1, wherein determining further includes calculating the planned capacity level based on the first amount of orders and a vehicle type associated with the vehicle.

5. The method of claim 1, wherein determining further includes receiving the planned capacity level through an interface with delivery details associated with the delivery.

6. The method of claim 1, wherein generating further includes determining whether a particular customer address is adjacent to the route based on a predefined deviation distance between the particular customer address and the route.

7. The method of claim 1, wherein generating further includes obtaining customer contact information associated with the customer addresses.

8. The method of claim 7, wherein sending further includes selecting the one or more customers from the customer contact information based on rules.

9. The method of claim 1, wherein sending further includes sending the requests as offers to the one or more customers, wherein the offers expire when unredeemed by the one or more customers within a predefined period of time before a delivery start time of the delivery.

10. The method of claim 1, wherein modifying further includes sending a delivery identifier for the delivery and details associated with the new orders to a delivery planning service to have the new orders included with the first amount of orders with the delivery.

11. The method of claim 1 further comprising, maintaining metrics for the delivery, the first amount of orders, and an increase in the planned capacity level based on adding the new orders to the delivery.

12. A method, comprising:
receiving a planned route for a planned delivery that is scheduled to deliver a first amount of orders along the planned route at a delivery start date and time;
obtaining an estimated remaining capacity level for a vehicle after the first amount of orders are loaded into the vehicle based on a type of vehicle associated with the vehicle;
identifying contact information for customers having addresses located on or adjacent to the planned route;
sending offers to devices operated by the customers, wherein the offers include an expiration date that precedes the delivery start date and time;
acquiring new orders from one or more of the customers after the sending; and
providing the new orders to a delivery planning service that modifies the planned delivery to include the new orders and reduces the estimated remaining capacity level of the vehicle for the planned delivery.

13. The method of claim 12 further comprising maintaining fuel/emissions saved per order for the planned delivery based on the planned route, the first amount of orders, and a second amount of orders comprising the first amount of orders plus the new orders.

14. The method of claim 12, wherein obtaining further includes receiving the estimated remaining capacity level from a trained machine-learning algorithm that is provided as input details associated with the first amount of orders and the vehicle type.

15. The method of claim 12, wherein obtaining further includes receiving an indication from an interface that indicates the vehicle has been loaded with the first amount of orders for the planned delivery.

16. The method of claim 15, wherein receiving further includes acquiring the estimated remaining capacity level from one or more sensors located in or associated with a cargo area of the vehicle.

17. The method of claim 12, wherein identifying further includes identifying the contact information for the customers based: on the addresses, customer transaction histories associated with the customers, and order details associated with the first amount of orders.

18. The method of claim 12, wherein acquiring further includes adjusting the offers to new offers after a predetermined period of time when less than an expected amount of new orders are acquired and iterate back to the sending.

19. A system, comprising:
a platform server comprising a platform processor and a platform non-transitory computer-readable storage medium having executable instructions representing a delivery;
a retail server comprising a retail processor and a retail non-transitory computer-readable storage medium having executable instructions representing a platform interface;
a mobile device comprising a mobile processor and a mobile non-transitory computer-readable storage medium having executable instructions representing a mobile application;
the delivery manager when executed by the platform processor from the platform non-transitory computer-readable storage medium causes the platform processor to:
generate a delivery from a first amount of orders based on order addresses associated with the first amount of orders;
generate a delivery route for the delivery;
receive a remaining capacity level for a delivery vehicle from the platform interface, the vehicle is scheduled to deliver the first amount of orders along the delivery route;
identify contact information for a customer of a retailer that has a customer address along or adjacent to the delivery route;
obtain an offer from the platform interface associated with the retailer to entice the customer to place a new order for the delivery;
send the offer to the mobile application of the mobile device that is operated by the customer using the contact information;
receive the new order for the delivery from the mobile application after sending the offer; and
modify the delivery to include the new order with the first amount of orders.
the platform interface when executed by the retail processor from the retail non-transitory computer-readable storage medium causes the retail processor to:
provide the remaining capacity level to the delivery manager after the vehicle is loaded with the first amount of orders for the delivery;
provide the offer to the delivery manager based on the contact information of the customer provided by the delivery manager and order details associated with the first amount of orders of the delivery;
send the new order details to a vehicle loading device to cause the vehicle to add the new order to the vehicle with the first amount of orders;
the mobile application when executed by the mobile processor from the mobile non-transitory computer-readable storage medium causes the mobile processor to:
receive the offer from the delivery manager; and
place the new order based on options selected by the customer through an order interface with the delivery manager.

20. The system of claim 19, wherein the platform server is a cloud processing environment, the retail server is a cloud processing environment, and the mobile device is: a tablet, a phone, a desktop, a laptop, a wearable processing device, or a voice-enabled network-based Internet-of-Things (IoTs) device.
